(19) United States
(12) Patent Application Publication
(10) Pub. No.: US 2006/0099924 A1
(43) Pub. Date: May 11, 2006

(54) Inquiry device in non-contact ic card system

(76) Inventors: Masahide Hayama, Kanagawa (JP); Hideyuki Nebiya, Tokyo (JP); Kotomi Uetake, Tokyo (JP)

Correspondence Address: PITNEY HARDIN LLP, 7 TIMES SQUARE, NEW YORK, NY, 10036-7311, US

(21) Appl. No.: 10/537,457

(22) PCT Filed: Jul. 7, 2003
(86) PCT No.: PCT/JP03/08617

§ 371 Date: Nov. 22, 2005

(30) Foreign Application Priority Data
Dec. 4, 2002 (JP) 2002-352377

(51) Int. Cl. H04B 7/00

(52) U.S. Cl. 455/260

(57) ABSTRACT

An inquiry device in the conventional non-contact IC card system has a problem that the electronic circuit size is large and complicated, requiring a very expensive high frequency part to increase the cost. In order to solve this problem, a part of the signal processing function realized by an electronic circuit in an inquiry device is performed by a receiving antenna and a receiving high frequency amplifier, thereby significantly reducing the electronic circuit size. The inquiry device includes a carrier oscillator connected to a transmitting mixer, a receiver section, and a receiving high frequency amplifier for amplifying the receiving high frequency received by the receiver section. The inquiry device in the non-contact IC card system is characterized in that a carrier generated by the carrier oscillator is interference-input to the receiving high frequency amplifier so as to modulate the receiving high frequency. As compared to the conventional method, the power distributor and the frequency converter can be omitted.

### BACKGROUND OF THE INVENTION

1. Field of the Invention

The present invention relates to a non-contact IC (integrated circuit) card communication system, which comprises an interrogator and a responder.

2. Description of the Prior Art

In recent years, automatic-identification technology for objects has been widely used. The widely used bar-code system is a leading technology of the automatic-identification technologies for objects. However, this bar-code system does now allow information to be rewritten; thus, the non-contact IC card system, in which it is possible to rewrite and read information by utilizing electronic circuitry via wireless communication, has emerged.

The non-contact IC card system is a system wherein information is written and stored in an IC card in another place via a wireless communication, or information stored in an IC card is received on a wireless communication. The embodiment thereof comprises, for example as shown in FIG. 3, the responder 0301 corresponding to the IC card, and the interrogator 0302.

FIG. 2 is a functional block diagram of an interrogator of the conventional method. The interrogator comprises the carrier oscillator 0201, the power divider 0202, the transmitting mixer 0203, the logic circuit 0204, the transmitting high-frequency amplifier 0205, the transmitter unit 0206, the receiver unit 0207, the receiving high-frequency amplifier 0208, the frequency converter 0209, and the low-pass filter 0210. (Japanese Patent Publication No. H08-227468)

Next, the operation of an interrogator of the conventional method will be described. In transmission, there is a mode of writing information to the responder and a mode of reading information from the responder.

In the writing mode, first, a carrier is generated for communication in the carrier oscillator 0201 and divided two signals in the power divider 0202. Next, modulation is executed on one of the signals in the transmitting mixer 0203 by information signal outputted from the logic circuit 0204, power amplification is executed in the transmitting high-frequency amplifier 0205, a radio wave is emitted from the transmitter unit 0206 (e.g. transmitting antenna) to the responder, and information is written in the responder.

In reading mode, although operations are similar to those of the writing mode, information signal is not outputted from the logic circuit 0204, and the carrier is outputted without modulation from the transmitting mixer 0203. The carrier is power-amplified in the transmitting high-frequency amplifier 0205, and the carrier for receiving information from the responder is transmitted from the transmitter unit 0206 to the responder.

Meanwhile, reception is executed with transmission of the above reading mode at the same time. The radio wave from the response unit, which is inputted from the receiver unit 0207 (e.g. receiving antenna), is amplified by the receiving high-frequency amplifier 0208, and the carrier, which is generated by the carrier oscillator 0201 and is divided by the power divider 0202, are mixed by the frequency converter 0209. As a result of the output, frequency-wise, signals of sum and difference of the receiving wave and the carrier are generated. In the low-pass filter 0210, the difference, therefore, the information component, which is band-limited by the responder, is extracted, inputted to the logic circuit 0204, and demodulated. The logic circuit 0204 is connected to external information apparatus.

However, the above interrogator in the conventional non-contact IC card system has deficiencies in size and complexity of the electronic circuitry thereof, and in the high cost of high-frequency components.

### SUMMARY

The present invention resolves the above deficiency and provides a method, wherein a part of the signal processing function realized by an electronic circuit in an interrogator is performed by a receiving antenna and a receiving high-frequency amplifier, thereby significantly reducing the electronic circuit size. An interrogator comprising, a carrier oscillator connected to a transmitting mixer, a receiver unit, and a receiving high frequency amplifier for amplifying the receiving high-frequency received by said receiver unit, wherein the carrier generated by the carrier oscillator is interference-inputted to the receiving high-frequency amplifier, thereby modulating said receiving high-frequency.

### BRIEF DESCRIPTION OF THE DRAWINGS

FIG. 1 is a functional block diagram of the interrogator of the present invention.

FIG. 2 is a functional block diagram of the interrogator of the conventional method.

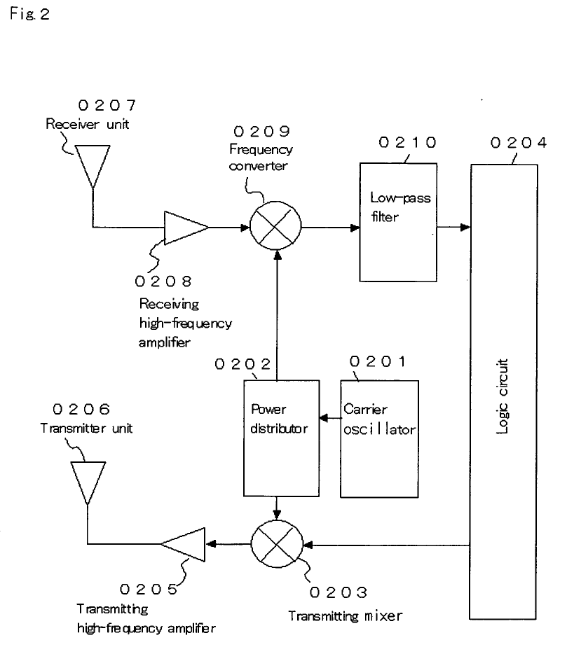

FIG. 3 is a block diagram of the non-contact IC card system.

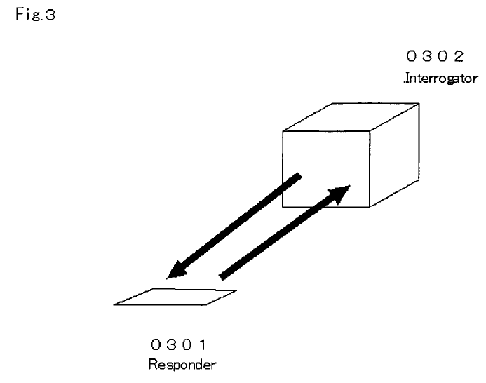

FIG. 4 is a functional block diagram of the interrogator of the sixth embodiment of the present invention.

### DETAILED DESCRIPTION

Hereinafter, the present invention will be described by utilizing drawings.

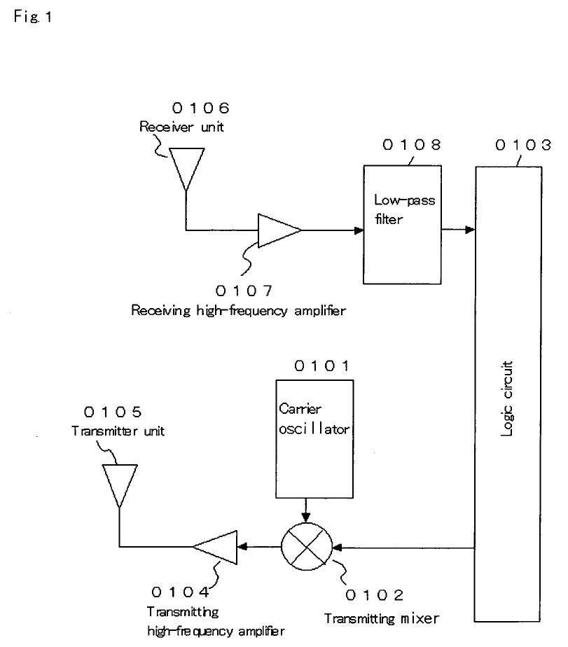

As shown in FIG. 1, the interrogator of the present invention comprises the carrier oscillator 0101, the receiver unit 0106, and the receiving high-frequency amplifier 0107, and generally comprises the transmitting mixer 0102, the logic circuit 0103, the transmitting high-frequency amplifier 0104, the transmitter unit 0105, and the low-pass filter 0108.

The operation of the interrogator of the present invention will be described. In transmission, as in the conventional method, there is a mode of writing information to the responder and a mode of reading information from the responder.

In the writing mode, first, a carrier is generated for communication in the carrier oscillator 0101. Next, modulation is executed in the transmitting mixer 0102 by information signal outputted from the logic circuit 0103, power amplification is executed in the transmitting high-frequency amplifier 0104, radio wave is emitted from the transmitter unit 0105 (e.g. transmitting antenna) to the responder, and information is written in the responder.

In reading mode, although operations are similar to those of the writing mode, first, a carrier is generated for communication in the carrier oscillator 0101. Here, if the information signal is not outputted from the logic circuit 0103, the carrier is outputted without modulation from the transmitting mixer 0102. The carrier is power amplified in the transmitting high-frequency amplifier 0104, and radio wave is emitted from the transmitter unit 0105 to the responder. Here, the carrier from the transmitter unit 0105 is inputted to the receiver unit 0106 (e.g. receiving antenna).

Meanwhile, in reception, the radio wave from the response unit and the carrier from the transmitter unit 0105 are mixed in the receiver unit 0106, and the signal is inputted to the receiving high-frequency amplifier 0107 and amplified. Here, since the signal strength of the carrier from the transmitter unit 0105 is high, it is amplified in a non-linear area of the amplifier and distortion is generated, so that the frequency conversion is operated. Therefore, as the output of the frequency converter of the conventional method, frequency-wise, signals of sum and difference of reception wave and the carrier are generated. The difference of the signal, therefore, the information from the responder is extracted in the low-pass filter 0108, and outputted to the logic circuit 0103. The logic circuit 0103 is connected to the external information apparatus.

The second embodiment of the invention is the interrogator according to the first embodiment, wherein the receiving high-frequency amplifier 0107, the carrier oscillator 0101, and the transmitting mixer 0102 are provided on an identical printed-circuit board, and the carrier oscillator 0101 is arranged between the receiving high-frequency amplifier 0107 and the transmitting mixer 0102.

The above embodiment enables easy interference-inputting.

The third embodiment of the invention is the interrogator according to either one of the first or second embodiments, wherein the carrier oscillator 0101 and the receiving high-frequency amplifier 0107 are arranged in an identical shield section.

The above constitution enables easy interference-inputting.

The fourth embodiment of the invention is the interrogator according to the first embodiment, wherein the interference-input from the carrier oscillator 0101 to the receiving high-frequency amplifier 0107 is executed by loose-coupling an antenna of the transmitter unit 0105 and an antenna of the receiver unit 0106.

Here, “loose-coupling an antenna of the transmitter unit 0105 and an antenna of the receiver unit 0106” corresponds to arranging the antenna of the transmitter unit 0105 and the antenna of the receiver unit 0106 so that they are adjacent to each other at an extremely close range. Moreover, there is no need to arrange the transmitter unit 0105 and the receiver unit 0106 on an identical printed-circuit or on an identical shield-section.

The fifth embodiment of the invention is the interrogator according to the first embodiment, wherein the interference-input from the carrier oscillator 0101 to the receiving high-frequency amplifier 0107 is executed by loose-coupling an output of the transmitting mixer 0102 and an input of the receiving high-frequency amplifier 0107 in a capacitor of low-capacitance. Here, “loose-coupling an output of the carrier oscillator 0101 and an input of the receiving high-frequency amplifier 0107 in a capacitor of low-capacitance” corresponds to utilizing a circuit, in which the output of the carrier oscillator 0101 and the input of the receiving high-frequency amplifier 0107 are coupled in the capacitor of low-capacitance. Moreover, there no need to arrange the carrier oscillator 0101 and the receiving high-frequency amplifier 0107 on an identical printed-circuit or in an identical shield-section.

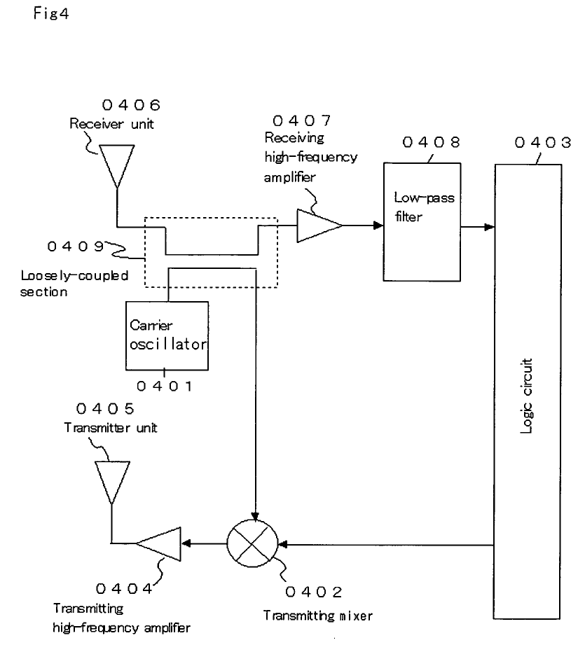

As shown in FIG. 4, an interrogator in the sixth embodiment of the invention comprises the carrier oscillator 0401, the receiver unit 0406, and the receiving high-frequency amplifier 0407, and generally comprises the transmitting mixer 0402, the logic circuit 0403, the transmitting high-frequency amplifier 0404, the transmitter unit 0405, and the low-pass filter 0408.

In the sixth embodiment of the invention is an interrogator, wherein the interference-input from the carrier oscillator 0401 to the reception high-frequency amplifier 0407 is executed by loose-coupling an output of the transmitting mixer 0402 and an input of the receiving high-frequency amplifier 0407 by mutual induction of transmission lines, which are parallel to each other. Here, “loose-coupling an output of the carrier oscillator 0401 and an input of the receiving high-frequency amplifier 0407 by mutual induction of transmission lines, which are parallel to each other” corresponds to coupling of the output of the carrier oscillator 0401 and the input of the receiving high-frequency amplifier 0407 by mutual induction of transmission lines, which are adjacent and parallel to each other. (the loose-coupled section 0409 are surrounded by dotted lines in FIG. 4) Moreover, “adjacent” corresponds to about 0.1 mm˜50 mm for frequency: about 1 MHz˜30 GHz. Furthermore, “transmission lines, which are parallel to each other” do not need to be provided on an identical layer of a substrate and may be provided on the other layers.

The present invention has is effective in significantly reducing circuit size by cutting off the power divider 0202 and the frequency converter 0209, however the operation of the present invention and that of the conventional method are the same.

As described hereinabove, according to the constitution of FIG. 1 of the present invention, it becomes able to cut off the power divider 0202 and the frequency converter 0209, thereby significantly reducing the circuit size and the manufacturing cost of products.

What is claimed is:

1. An interrogator comprising:
a carrier oscillator connected to a transmitting mixer,
a receiver unit, and
an receiving high-frequency amplifier for amplifying the receiving high-frequency received by said receiver unit, wherein
carrier generated by the carrier oscillator is interference-inputted to the receiving high-frequency amplifier, thereby modulating the receiving high-frequency.

2. The interrogator according to claim 1, wherein
said receiving high-frequency amplifier, said carrier oscillator, and said transmitting mixer are provided on an identical printed-circuit board, and
said carrier oscillator is arranged between said receiving high-frequency amplifier and said transmitting mixer.

3. The interrogator according to either of claims 1 or 2, wherein
said carrier oscillator and said receiving high-frequency amplifier are arranged in an identical shield section.

4. The interrogator according to claim 1, wherein
the interference-input from said carrier oscillator to said receiving high-frequency amplifier is executed by loose-coupling an antenna of the transmitter unit and an antenna of said receiver unit.

5. The interrogator according to claim 1, wherein
the interference-input from said carrier oscillator to said receiving high-frequency amplifier is executed by loose-coupling an output of said carrier oscillator and an input of said receiving high-frequency amplifier in a capacitor of low-capacitance.

6. The interrogator according to claim 1, wherein
the interference-input from said carrier oscillator to said receiving high-frequency amplifier is executed by loose-coupling an output of said transmitting mixer and an input of said receiving high-frequency amplifier by mutual induction of transmission lines, which are parallel to each other.
